(19) United States
(12) Patent Application Publication
(10) Pub. No.: US 2026/0347687 A1
(43) Pub. Date: Nov. 5, 2026

(54) METHOD FOR MANUFACTURING HYDROPHILIC QUANTUM DOT

(71) Applicant: SHIN-ETSU CHEMICAL CO., LTD., Tokyo (JP)

(72) Inventors: Yoshihiro NOJIMA, Annaka-shi (JP); Shinji AOKI, Annaka-shi (JP); Kazuya TOBISHIMA, Annaka-shi (JP)

(73) Assignee: SHIN-ETSU CHEMICAL CO., LTD., Tokyo (JP)

(21) Appl. No.: 19/488,151

(22) PCT Filed: Jun. 5, 2024
(86) PCT No.: PCT/JP2024/020572

§ 371 Date: Nov. 26, 2025

(30) Foreign Application Priority Data
Jun. 19, 2023 (JP) 2023-099851

(51) Int. Cl. C09K 11/02; B82Y 20/00; B82Y 40/00; C09K 11/08; C09K 11/88

(52) U.S. Cl. CPC C09K 11/025; C09K 11/0883; C09K 11/883; B82Y 20/00; B82Y 40/00

(57) ABSTRACT

A method for manufacturing a hydrophilic quantum dot, the method including: adding a metal halide, two or more phosphorus compounds, an organic acid having a thiol group or an alcohol having a thiol group, and an aprotic polar solvent to a hydrophobic quantum dot dispersed in a nonpolar solvent, followed by heating to effect a hydrophilic treatment of the hydrophobic quantum dot. Thus, the invention provides a method for manufacturing a hydrophilic quantum dot, which enables hydrophilization without deteriorating the characteristics of the quantum dot in the hydrophilic treatment.

### TECHNICAL FIELD

The present invention relates to a method for manufacturing a hydrophilic quantum dot.

### BACKGROUND ART

Semiconductor crystal particles with nanosized particle diameters are called quantum dots, and excitons generated upon light absorption are confined in nanosized region, so that energy level of the semiconductor crystal particles becomes discrete. Moreover, band gap thereof changes depending on the particle diameter. Due to these effects, the fluorescence emission by quantum dots is brighter and more efficient than those by common phosphors and exhibits sharp light emission.

In addition, based on such nature that the band gap varies depending on the particle diameter, quantum dots are characterized in that the emission wavelength is controllable and are expected to be applied as a wavelength conversion material for solid-state lighting and displays. For example, the use of quantum dots as a wavelength conversion material in a display enables a wider color range and lower power consumption than conventional phosphor materials.

Proposed is a method for assembling quantum dots for use as a wavelength conversion material, the method including dispersing quantum dots in a resin material and laminating the resin material containing the quantum dots with a transparent film to thereby incorporate the laminated film into a backlight unit as a wavelength conversion film (Patent Document 1).

Furthermore, proposed is an application to image elements with high efficiency and excellent color reproducibility by using quantum dots as a color filter material so that the quantum dots absorb blue monochromatic light from a backlight unit and emit red or green light to thereby function as a color filter and a wavelength conversion material (Patent Document 2).

For such applications, it is common to mix quantum dots with a photocurable, thermosetting, or thermoplastic polymer or a monomer that is polymerized by light or heat to form a film or a color filter, and the compatibility between the quantum dots and the polymer or monomer is important as the compatibility affects stability and properties.

### CITATION LIST

### Patent Literature

Patent Document 1: JP 2013-544018 A

Patent Document 2: JP 2017-21322 A

### SUMMARY OF INVENTION

### Technical Problem

However, the surface of quantum dots is hydrophobic due to the presence of ligands such as thiols, carboxylic acids, and amines bearing a long-chain alkyl group. In contrast, a photopolymerizable or thermally polymerizable polymer, monomer, or the like has a polymerizable functional group such as an acrylic group or an epoxy group, and thus has polarity, resulting in poor compatibility with quantum dots. This incompatibility leads to issues such as aggregation and reduced stability of the quantum dots. To address these problems, hydrophilic treatment of the quantum dots is performed.

Various methods have been investigated for the hydrophilic treatment of quantum dots, including micellization using an amphiphilic surfactant, deposition of a metal oxide layer such as silica, and introduction of a polar functional group via a silane coupling agent. Each of these methods tends to cause detachment of the native ligands present on the quantum dot surface, resulting in deterioration of emission and a decrease in stability.

The present invention has been made to address the above-described problems, and an object thereof is to provide a method for manufacturing a hydrophilic quantum dot, which enables hydrophilization without deteriorating the characteristics of a quantum dot in the hydrophilic treatment.

### Solution to Problem

The present invention has been made to achieve the object, and provides a method for manufacturing a hydrophilic quantum dot, the method comprising: adding a metal halide, two or more phosphorus compounds, an organic acid having a thiol group or an alcohol having a thiol group, and an aprotic polar solvent to a hydrophobic quantum dot dispersed in a nonpolar solvent, followed by heating to effect a hydrophilic treatment of the hydrophobic quantum dot.

According to such a method for manufacturing a hydrophilic quantum dot, hydrophilization can be achieved without deteriorating the characteristics of the quantum dot in the hydrophilic treatment.

In this context, a chloride, bromide, or iodide of zinc, gallium, indium, cadmium, silver, copper, aluminum, zirconium, titanium, magnesium, manganese, germanium, or lead can be used as the metal halide.

This is advantageous in suppressing the deterioration of the characteristics of the quantum dot in the hydrophilic treatment.

In this context, two or more selected from tributylphosphine, dibutylphenylphosphine, trihexylphosphine, trioctylphosphine, trioctylphosphine oxide, triphenylphosphine, triphenylphosphine oxide, diphenylpropylphosphine, methyldiphenylphosphine, isopropyldiphenylphosphine, tri (m-tolyl) phosphine, tri (p-tolyl) phosphine, diphenylpropylphosphine, cyclohexyldiphenylphosphine, and 4-(diphenylphosphino) benzoic acid can be used as the phosphorus compounds.

This is advantageous in performing the hydrophilic treatment.

In this context, any one selected from mercaptosuccinic acid, 3-mercaptoisobutyric acid, thiolactic acid, 3-mercaptopropionic acid, mercaptoundecanoic acid, 2-mercaptobenzoic acid, 3-mercaptobenzoic acid, 4-mercaptobenzoic acid, 2-mercaptoethanol, 3-hydroxybenzenethiol, 4-hydroxybenzenethiol, mercaptobutanol, mercaptopropanol, 6-mercaptohexanol, 2,3-dimercapto-1-propanol, and 1-thioglycerol can be used as the organic acid having a thiol group or the alcohol having a thiol group.

This is advantageous in performing hydrophilization without deteriorating the characteristics of the quantum dot in the hydrophilic treatment.

In this context, any one selected from N,N-dimethylformamide, acetonitrile, dimethyl sulfoxide, dimethylacetamide, and N-methylpyrrolidone can be used as the aprotic polar solvent.

This is advantageous in performing hydrophilization without deteriorating the characteristics of the quantum dot in the hydrophilic treatment.

In this context, the quantum dot after the hydrophilic treatment may have a higher quantum yield than the quantum dot before the hydrophilic treatment.

According to the method for manufacturing a hydrophilic quantum dot of the present invention, it is thus possible to improve the quantum yield of the quantum dot after the hydrophilic treatment compared to that before the hydrophilic treatment.

### Advantageous Effects of Invention

As described above, according to a method for manufacturing a hydrophilic quantum dot of the present invention, hydrophilization can be achieved without deteriorating the characteristics of the quantum dot in the hydrophilic treatment.

### BRIEF DESCRIPTION OF DRAWINGS

FIG. 1 is a flow diagram showing a method for manufacturing a hydrophilic quantum dot according to an embodiment of the present invention.

### DESCRIPTION OF EMBODIMENTS

Hereinafter, the present invention will be described in detail, but the present invention is not limited thereto.

As described above, there has been a demand for a method for manufacturing a hydrophilic quantum dot, which enables hydrophilization without deteriorating the characteristics of a quantum dot in a hydrophilic treatment.

As a result of diligent studies on the above-described problem, the present inventors have found that hydrophilization can be achieved without deteriorating the characteristics of a quantum dot in the hydrophilic treatment using a method for manufacturing a hydrophilic quantum dot, the method including: adding a metal halide, two or more phosphorus compounds, an organic acid having a thiol group or an alcohol having a thiol group, and an aprotic polar solvent to a hydrophobic quantum dot dispersed in a nonpolar solvent, followed by heating to effect a hydrophilic treatment of the hydrophobic quantum dot, thus completing the present invention.

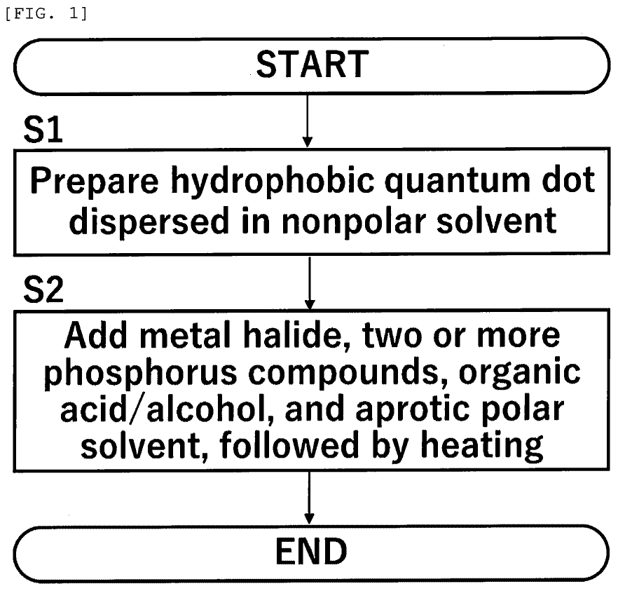

Hereinafter, a method for manufacturing a hydrophilic quantum dot according to an embodiment of the present invention, specifically, a method for manufacturing a hydrophilic quantum dot soluble in a polar solvent, will be described with reference to FIG. 1.

First, a hydrophobic quantum dot dispersed in a nonpolar solvent is prepared (S1 in FIG. 1).

In the present invention, the hydrophobic quantum dot is not particularly limited in terms of composition or production method as long as the hydrophobic quantum dot exhibits hydrophobicity. A quantum dot may be selected according to the purpose. Examples of the composition of the quantum dot include a II-IV group semiconductor, a III-V group semiconductor, a II-VI group semiconductor, a I-III-VI group semiconductor, a II-IV-V group semiconductor, a IV group semiconductor, and a perovskite-type semiconductor.

In addition, the quantum dot may have only a core or a core-shell structure.

Specific examples of the core material include CdSe, CdS, CdTe, InP, InAs, InSb, AlP, AlAs, AlSb, ZnSe, ZnS, ZnTe, Zn₃P₂, GaP, GaAs, GaSb, CuInSe₂, CuInS₂, CuInTe₂, CuGaSe₂, CuGaS₂, CuGaTe₂, CuAlSe₂, CuAlS₂, CuAlTe₂, AgInSe₂, AgInS₂, AgInTe₂, AgGaSe₂, AgGaS₂, AgGaTe₂, PbSe, PbS, PbTe, Si, Ge, graphene, CsPbCl₃, CsPbBr₃, CsPbI₃, CH₃NH₃PbCl₃, and a mixed crystal thereof or those added with a dopant.

Examples of the shell material include ZnO, ZnS, ZnSe, ZnTe, CdS, CdSe, CdTe, AlN, AlP, AlAs, AlSb, GaN, GaP, GaAs, GaSb, InN, InP, InAs, AlSb, BeS, BeSe, BeTe, MgS, MgSe, MgTe, PbS, PbSe, PbTe, SnS, SnSe, SnTe, CuF, CuCl, CuBr, CuI, and a mixed crystal thereof.

Furthermore, the shape of the quantum dot may be spherical, cubic, or rod-shaped. The shape of the quantum dot is not particularly limited and may be selected freely.

The particle size of the quantum dot may be appropriately selected according to the desired wavelength range, but the average particle size is preferably 20 nm or less. When the average particle size is 20 nm or less, the quantum size effect can be reliably obtained, thereby facilitating improvements in emission efficiency and control of the band gap based on particle size.

The particle size of the quantum dots can be calculated from the average value of maximum diameters in a predetermined direction, that is, the Feret diameter, of 20 or more particles, by measuring a particle image obtained by a transmission electron microscope (TEM). Of course, the method for measuring the average particle size is not limited thereto, and other methods can be used for the measurement.

A ligand may be present on the surface of the quantum dot, and examples thereof include oleic acid, stearic acid, palmitic acid, myristic acid, lauric acid, decanoic acid, octanoic acid, oleylamine, stearyl (octadecyl) amine, dodecyl (lauryl) amine, decylamine, octylamine, octadecanethiol, hexadecanethiol, tetradecanethiol, dodecanethiol, decanethiol, octanethiol, trioctylphosphine, trioctylphosphine oxide, triphenylphosphine, triphenylphosphine oxide, tributylphosphine, and tributylphosphine oxide.

The nonpolar solvent is not particularly limited and may be freely selected as long as the quantum dot has good dispersibility. The nonpolar solvent is preferably a solvent that is not miscible with an aprotic polar solvent. Examples of the nonpolar solvent include hexane, cyclohexane, pentane, toluene, heptane, and 1-octadecene.

Next, a metal halide, two or more phosphorus compounds, an organic acid having a thiol group or an alcohol having a thiol group, and an aprotic polar solvent are added to the hydrophobic quantum dot dispersed in the nonpolar solvent and heated to effect a hydrophilic treatment of the hydrophobic quantum dot (S2 in FIG. 1).

The metal halide is not particularly limited, and a metal halide suitable for the composition of the quantum dots is preferred. For example, in the case of an InP/ZnS core-shell quantum dot, a halide of zinc or indium is preferably used. The type of halogen is not particularly limited, and a chloride, bromide, or iodide is preferred.

Specifically, the metal halide that can be used is a chloride, bromide, or iodide of zinc, gallium, indium, cadmium, silver, copper, aluminum, zirconium, titanium, magnesium, manganese, germanium, or lead.

The amount of metal halide added is, in terms of weight ratio, preferably 2 or more, and particularly preferably 5 or more, assuming that the weight of the quantum dot is 1.

The combination and mixing ratio of two or more phosphorus compounds may be freely selected and appropriately selected according to the type of quantum dot and the type and combination of phosphorus compounds. When only one phosphorus compound is used, hydrophilization becomes insufficient.

The smaller the steric hindrance of the ligand is, the more easily the coordination to the quantum dot occurs. On the other hand, the smaller the steric hindrance is, the more easily the aggregation of quantum dots occurs. When the aggregation occurs, only a part of the existing ligands is exchanged, and hydrophilization does not proceed. Therefore, two phosphorus compounds can be combined to replace the existing ligands on the surface of the quantum dots with a phosphorus compound having high coordination and also exchange a phosphorus compound having low coordination and large steric hindrance with the phosphorus compound having high coordination, thereby suppressing the aggregation of quantum dots and efficiently promoting the exchange of ligands on the surface of the quantum dots.

The phosphorus compounds preferably include two or more selected from tributylphosphine, dibutylphenylphosphine, trihexylphosphine, trioctylphosphine, trioctylphosphine oxide, triphenylphosphine, triphenylphosphine oxide, diphenylpropylphosphine, methyldiphenylphosphine, isopropyldiphenylphosphine, tri (m-tolyl) phosphine, tri (p-tolyl) phosphine, diphenylpropylphosphine, cyclohexyldiphenylphosphine, and 4-(diphenylphosphino) benzoic acid.

The amount of phosphorus compound added is, in terms weight ratio, preferably 5 or more, and particularly preferably 10 or more, assuming that the weight of the quantum dot is 1.

The organic acid having a thiol group or the alcohol having a thiol group to be preferably used is mercaptosuccinic acid, 3-mercaptoisobutyric acid, thiolactic acid, 3-mercaptopropionic acid, mercaptoundecanoic acid, 2-mercaptobenzoic acid, 3-mercaptobenzoic acid, 4-mercaptobenzoic acid, 2-mercaptoethanol, 3-hydroxybenzenethiol, 4-hydroxybenzenethiol, mercaptobutanol, mercaptopropanol, 6-mercaptohexanol, 2, 3-dimercapto-1-propanol, or 1-thioglycerol.

The amount of an organic acid having a thiol group or an alcohol having a thiol group added is, in terms of weight ratio, preferably 10 or more, and particularly preferably 20 or more by weight, assuming that the weight of the quantum dot is 1. The organic acid having a thiol group or the alcohol having a thiol group may be freely selected and appropriately selected according to the type of quantum dot and the type and combination of phosphorus compounds to be added.

The aprotic polar solvent is preferably a solvent that is not miscible with the nonpolar solvent, and N,N-dimethylformamide, acetonitrile, dimethyl sulfoxide, dimethylacetamide, or N-methylpyrrolidone is preferably used.

The amount of aprotic polar solvent added may be freely selected and appropriately selected according to the desired concentration of quantum dots after the hydrophilic treatment.

In this manner, the method for manufacturing a hydrophilic quantum dot involves adding a metal halide, two or more phosphorus compounds, an organic acid having a thiol group or an alcohol having a thiol group, and an aprotic polar solvent to a hydrophobic quantum dot dispersed in a nonpolar solvent and heating the mixture, thereby making the quantum dot hydrophilic and extracting the quantum dot from the nonpolar solvent into the aprotic polar solvent. The heating temperature is preferably 50 °C or more, and particularly preferably 100 °C or more and lower than the boiling point of the solvent. The heating time may be the time required for the quantum dot to be extracted from the nonpolar solvent into the aprotic polar solvent, for example, about 60 minutes.

In this context, the quantum dot after the hydrophilic treatment may have a higher quantum yield, such as internal quantum efficiency, than the quantum dot before the hydrophilic treatment. According to the method for manufacturing a hydrophilic quantum dot of the present invention, it is possible to improve the quantum yield of the quantum dot after the hydrophilic treatment compared to that before the hydrophilic treatment.

### EXAMPLE

Hereinafter, the present invention will be described in more detail with reference to Examples and Comparative Examples of the present invention. However, the present invention is not limited thereto.

In Examples and Comparative Examples, core-shell quantum dots of InP/ZnSe/ZnS were used as quantum dot materials.

### Quantum Dot Core Synthesis Step

In a flask, 0.23 g (0.9 mmol) of palmitic acid, 0.088 g (0.3 mmol) of indium acetate, and 10 ml of 1-octadecene were placed, heated at 100 °C under reduced pressure with stirring, and degassed for 1 hour while dissolving the raw materials. Thereafter, nitrogen was purged into the flask, 0.75 mL (0.15 mmol) of a solution prepared by mixing tris (trimethylsilyl) phosphine with trioctylphosphine and adjusting to 0.2 M was added, and the temperature was raised to 300 °C. It was confirmed that the solution changed from yellow to red, and core particles were formed.

### Quantum Dot Shell Layer Synthesis Step

Subsequently, 2.85 g (4.5 mmol) of zinc stearate and 15 mL of 1-octadecene were added to another flask, heated to 100 °C under reduced pressure with stirring, and degassed for 1 hour while dissolving to thereby prepare a 0.3 M zinc stearate octadecene solution. 3.0 mL (0.9 mmol) thereof was added to the reaction solution after core synthesis, followed by cooling to 200 °C.

Then, 0.474 g (6 mmol) of selenium and 4 mL of trioctylphosphine were added to a separate flask and dissolved by heating to 150 °C to prepare a 1.5 M selenium trioctylphosphine solution. While the temperature of the reaction solution after the core synthesis step, which had been cooled to 200 °C, was raised to 320 °C over 30 minutes, the selenium trioctylphosphine solution was added at 0.1 mL increments, totaling 0.6 mL (0.9 mmol). The mixture was maintained at a temperature of 320 °C for 10 minutes and then cooled to room temperature.

Thereafter, 0.44 g (2.2 mmol) of zinc acetate was added and dissolved by heating to 100 °C under reduced pressure and stirring. After the inside of the flask was purged with nitrogen again, the temperature was raised to 230 °C, 0.98 mL (4 mmol) of 1-dodecanethiol was added, and the mixture was maintained for 1 hour. The resulting solution was cooled to room temperature to prepare a solution containing core-shell quantum dots composed of InP/ZnSe/ZnS.

### Quantum Dot Dispersion Step

After completion of the reaction, the solution was cooled to room temperature, followed by the addition of ethanol to precipitate the reaction product, and centrifugation was performed to remove the supernatant. The same purification procedure was performed again, and the resulting precipitate was dispersed in hexane, a nonpolar solvent, to obtain a hexane solution containing quantum dots dispersed. The concentration of quantum dots in this solution was 1 wt%.

When the emission wavelength, fluorescence emission half-width and fluorescence emission efficiency (internal quantum efficiency) of the quantum dots at an excitation wavelength of 450 nm were measured using quantum efficiency measurement system (QE-2100) manufactured by Otsuka Electronics Co., Ltd., the emission wavelength was 533 nm, the half-width was 40 nm, and the internal quantum efficiency was 70%.

### Example 1

In a 50-mL flask, 5 mL of the hexane solution containing quantum dots dispersed was placed, 0.2 g of triphenylphosphine and 1.0 mL of trioctylphosphine were added thereto, and the mixture was stirred. Further, 0.25 g of zinc bromide and 5 mL of N,N-dimethylformamide were added while stirring.

After all solids had dissolved, 0.4 mL of 3-mercaptopropionic acid was added. After being stirred at room temperature for a while, the mixture was heated under reflux at 100 °C for 60 minutes to carry out the reaction. After the reaction, the quantum dots migrated from the hexane layer to the N,N-dimethylformamide layer, and thus hydrophilized quantum dots were obtained.

When the emission wavelength, fluorescence emission half-width and fluorescence emission efficiency (internal quantum efficiency) of the quantum dots after the hydrophilic treatment were measured under the same conditions as those immediately after the quantum dot dispersion step, the emission wavelength was 533 nm, the half-width was 40 nm, and the internal quantum efficiency was 81%.

### Example 2

In a 50-mL flask, 5 mL of the hexane solution containing quantum dots dispersed was placed, 0.2 g of isopropyldiphenylphosphine and 1.0 ml of trioctylphosphine were added thereto, and the mixture was stirred. Further, 0.25 g of aluminum chloride and 5 mL of dimethyl sulfoxide were added while stirring.

After all solids had dissolved, 0.4 mL of 6-mercaptohexanol was added. After being stirred at room temperature for a while, the mixture was heated under reflux at 100 °C for 60 minutes to carry out the reaction. After the reaction, the quantum dots migrated from the hexane layer to the dimethyl sulfoxide layer, and thus hydrophilized quantum dots were obtained.

When the emission wavelength, fluorescence emission half-width and fluorescence emission efficiency (internal quantum efficiency) of the quantum dots after the hydrophilic treatment were measured in the same manner as in Example 1, the emission wavelength was 533 nm, the half-width was 39 nm, and the internal quantum efficiency was 77%.

### Comparative Example 1

In a 50-mL flask, 5 mL of the hexane solution containing quantum dots dispersed was placed, 1.0 g of triphenylphosphine was added thereto, and the mixture was stirred. As described above, only one phosphorus compound was added in Comparative Example 1. Further, 0.25 g of zinc bromide and 5 mL of N,N-dimethylformamide were added while stirring.

After all solids had dissolved, 0.4 mL of 6-mercaptohexanol was added. After being stirred at room temperature for a while, the mixture was heated under reflux at 100 °C for 60 minutes to carry out the reaction. After the reaction, most of the quantum dots remained in the hexane layer. Therefore, hydrophilization of the quantum dots was insufficient.

### Comparative Example 2

In a 50-mL flask, 5 mL of the hexane solution containing quantum dots dispersed was placed, 0.25 g of zinc bromide and 5 mL of N,N-dimethylformamide were added thereto. After all solids had dissolved, 0.4 mL of 3-mercaptopropionic acid was added.

After being stirred at room temperature for a while, the mixture was heated under reflux at 100 °C for 60 minutes to carry out the reaction. After the reaction, the quantum dots migrated from the hexane layer to the N,N-dimethylamide layer, and thus hydrophilized quantum dots were obtained. As described above, in Comparative Example 2, hydrophilic treatment was performed without addition of a phosphorus compound.

When the emission wavelength, fluorescence emission half-width and fluorescence emission efficiency (internal quantum efficiency) of the quantum dots after the hydrophilic treatment were measured in the same manner as in Example 1, the emission wavelength was 536 nm, the half-width was 42 nm, and the internal quantum efficiency was 52%. Accordingly, the internal quantum efficiency after the hydrophilic treatment decreased compared to that before the hydrophilic treatment.

### Comparative Example 3

In a 50-mL flask, 5 mL of the hexane solution containing quantum dots dispersed was placed, 0.2 g of isopropyldiphenylphosphine and 1.0 mL of trioctylphosphine were added thereto, and the mixture was stirred. Further, 5 mL of dimethyl sulfoxide was added while stirring.

After all solids had dissolved, 0.4 mL of 6-mercaptohexanol was added. After being stirred at room temperature for a while, the mixture was heated under reflux at 100 °C for 60 minutes to carry out the reaction. After the reaction, the quantum dots migrated from the hexane layer to the dimethyl sulfoxide layer, and thus hydrophilized quantum dots were obtained. As described above, in Comparative Example 3, hydrophilic treatment was performed without addition of a metal halide.

When the emission wavelength, fluorescence emission half-width and fluorescence emission efficiency (internal quantum efficiency) of the quantum dots after the hydrophilic treatment were measured in the same manner as in Example 1, the emission wavelength was 535 nm, the half-width was 45 nm, and the internal quantum efficiency was 43%. Accordingly, the internal quantum efficiency after the hydrophilic treatment decreased compared to that before the hydrophilic treatment.

Thus, in Comparative Examples, the hydrophilic treatment was insufficient (Comparative Example 1), and a decrease in the emission intensity due to the hydrophilic treatment was confirmed (Comparative Examples 2 and 3). On the other hand, in Examples, the hydrophilic treatment proceeded completely without a decrease in the quantum yield due to the hydrophilic treatment.

As described above, it was confirmed that when the quantum dots were subjected to the hydrophilic treatment according to the method for manufacturing a hydrophilic quantum dot of the present invention, the hydrophilic treatment was performed without deterioration of the emission characteristics of the quantum dots.

The present description includes the following embodiments.
[1]: A method for manufacturing a hydrophilic quantum dot, the method comprising:
adding a metal halide, two or more phosphorus compounds, an organic acid having a thiol group or an alcohol having a thiol group, and an aprotic polar solvent to a hydrophobic quantum dot dispersed in a nonpolar solvent, followed by heating to effect a hydrophilic treatment of the hydrophobic quantum dot.
[2]: The method for manufacturing a hydrophilic quantum dot according to the above [1], wherein a chloride, bromide, or iodide of zinc, gallium, indium, cadmium, silver, copper, aluminum, zirconium, titanium, magnesium, manganese, germanium, or lead is used as the metal halide.
[3]: The method for manufacturing a hydrophilic quantum dot according to the above [1] or [2], wherein two or more selected from tributylphosphine, dibutylphenylphosphine, trihexylphosphine, trioctylphosphine, trioctylphosphine oxide, triphenylphosphine, triphenylphosphine oxide, diphenylpropylphosphine, methyldiphenylphosphine, isopropyldiphenylphosphine, tri (m-tolyl) phosphine, tri (p-tolyl) phosphine, diphenylpropylphosphine, cyclohexyldiphenylphosphine, and 4-(diphenylphosphino) benzoic acid are used as the phosphorus compounds.
[4]: The method for manufacturing a hydrophilic quantum dot according to any of the above [1] to [3], wherein any one selected from mercaptosuccinic acid, 3-mercaptoisobutyric acid, thiolactic acid, 3-mercaptopropionic acid, mercaptoundecanoic acid, 2-mercaptobenzoic acid, 3-mercaptobenzoic acid, 4-mercaptobenzoic acid, 2-mercaptoethanol, 3-hydroxybenzenethiol, 4-hydroxybenzenethiol, mercaptobutanol, mercaptopropanol, 6-mercaptohexanol, 2,3-dimercapto-1-propanol, and 1-thioglycerol is used as the organic acid having a thiol group or the alcohol having a thiol group.
[5]: The method for manufacturing a hydrophilic quantum dot according to any of the above [1] to [4], wherein any one selected from N,N-dimethylformamide, acetonitrile, dimethyl sulfoxide, dimethylacetamide, and N-methylpyrrolidone is used as the aprotic polar solvent.
[6]:The method for manufacturing a hydrophilic quantum dot according to any of the above [1] to [5], wherein a quantum dot after the hydrophilic treatment has a higher quantum yield than the quantum dot before the hydrophilic treatment.

Note that the present invention is not limited to the above-described embodiments. The embodiments are just examples, and any embodiments that substantially have the same feature and demonstrate the same functions and effects as those in the technical concept described in claims of the present invention are included in the technical scope of the present invention.

1-6. (canceled)

7. A method for manufacturing a hydrophilic quantum dot, the method comprising:
adding a metal halide, two or more phosphorus compounds, an organic acid having a thiol group or an alcohol having a thiol group, and an aprotic polar solvent to a hydrophobic quantum dot dispersed in a nonpolar solvent, followed by heating to effect a hydrophilic treatment of the hydrophobic quantum dot.

8. The method for manufacturing a hydrophilic quantum dot according to claim 7, wherein a chloride, bromide, or iodide of zinc, gallium, indium, cadmium, silver, copper, aluminum, zirconium, titanium, magnesium, manganese, germanium, or lead is used as the metal halide.

9. The method for manufacturing a hydrophilic quantum dot according to claim 7, wherein two or more selected from tributylphosphine, dibutylphenylphosphine, trihexylphosphine, trioctylphosphine, trioctylphosphine oxide, triphenylphosphine, triphenylphosphine oxide, diphenylpropylphosphine, methyldiphenylphosphine, isopropyldiphenylphosphine, tri(m-tolyl)phosphine, tri(p-tolyl)phosphine, diphenylpropylphosphine, cyclohexyldiphenylphosphine, and 4-(diphenylphosphino)benzoic acid are used as the phosphorus compounds.

10. The method for manufacturing a hydrophilic quantum dot according to claim 7, wherein any one selected from mercaptosuccinic acid, 3-mercaptoisobutyric acid, thiolactic acid, 3-mercaptopropionic acid, mercaptoundecanoic acid, 2-mercaptobenzoic acid, 3-mercaptobenzoic acid, 4-mercaptobenzoic acid, 2-mercaptoethanol, 3-hydroxybenzenethiol, 4-hydroxybenzenethiol, mercaptobutanol, mercaptopropanol, 6-mercaptohexanol, 2,3-dimercapto-1-propanol, and 1-thioglycerol is used as the organic acid having a thiol group or the alcohol having a thiol group.

11. The method for manufacturing a hydrophilic quantum dot according to claim 7, wherein any one selected from N,N-dimethylformamide, acetonitrile, dimethyl sulfoxide, dimethylacetamide, and N-methylpyrrolidone is used as the aprotic polar solvent.

12. The method for manufacturing a hydrophilic quantum dot according to claim 7, wherein a quantum dot after the hydrophilic treatment has a higher quantum yield than the quantum dot before the hydrophilic treatment.

13. The method for manufacturing a hydrophilic quantum dot according to claim 8, wherein a quantum dot after the hydrophilic treatment has a higher quantum yield than the quantum dot before the hydrophilic treatment.

14. The method for manufacturing a hydrophilic quantum dot according to claim 9, wherein a quantum dot after the hydrophilic treatment has a higher quantum yield than the quantum dot before the hydrophilic treatment.

15. The method for manufacturing a hydrophilic quantum dot according to claim 10, wherein a quantum dot after the hydrophilic treatment has a higher quantum yield than the quantum dot before the hydrophilic treatment.

16. The method for manufacturing a hydrophilic quantum dot according to claim 11, wherein a quantum dot after the hydrophilic treatment has a higher quantum yield than the quantum dot before the hydrophilic treatment.
